(19) United States
(12) Patent Application Publication
(10) Pub. No.: US 2015/0273702 A1
(43) Pub. Date: Oct. 1, 2015

(54) MECHANICAL ARM STRUCTURE AND PLATE

(71) Applicant: HON HAI PRECISION INDUSTRY CO., LTD., New Taipei (TW)

(72) Inventors: Yu-Chen TING, New Taipei (TW); Chih-Hang CHAO, New Taipei (TW)

(21) Appl. No.: 14/587,583

(22) Filed: Dec. 31, 2014

(30) Foreign Application Priority Data
Mar. 28, 2014 (TW) 103111625

(51) Int. Cl. B25J 18/00

(52) U.S. Cl. CPC B25J 18/00

(57) ABSTRACT

A mechanical arm structure includes two parallel base plates. At least one of the two base plates includes a hole in order to reduce the weight of the base plate. The mechanical arm structure includes a plurality of posts. The plurality of posts connects to the two base plates to enhance the rigidity of the mechanical arm structure along the direction perpendicular to the two base plates.

### CROSS-REFERENCE TO RELATED APPLICATIONS

This application claims priority to Taiwanese Patent Application No. 103111625 filed on Mar. 28, 2014, the contents of which are incorporated by reference herein.

### FIELD

The subject matter herein generally relates to mechanical arm structures.

### BACKGROUND

Robots are widely used in industrial production because of automation and high efficiency. A robotic arm is a type of mechanical arm structure, usually programmable, with similar functions to a human arm, and can be designed to perform any desired task such as welding, gripping, spinning etc.

### BRIEF DESCRIPTION OF THE DRAWINGS

Implementations of the present technology will now be described, by way of example only, with reference to the attached figures.

FIG. 1 is an isometric view of one embodiment of a mechanical arm structure.

FIG. 2 is an isometric, cross-sectional view of the mechanical arm structure of FIG. 1.

FIG. 3 is similar to FIG. 1, but the mechanical arm structure is in a working state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a mechanical arm structure.

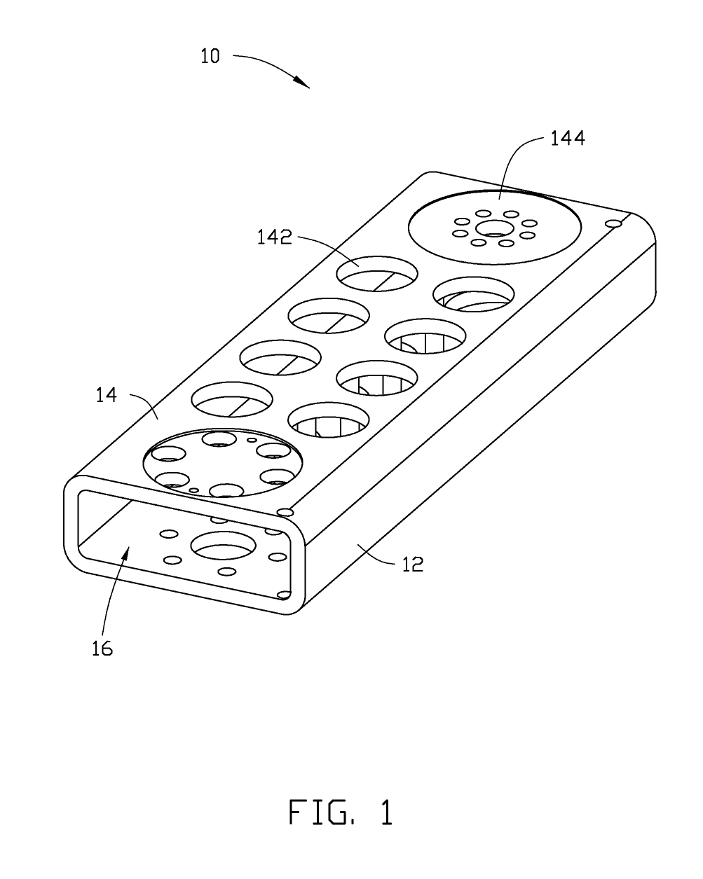

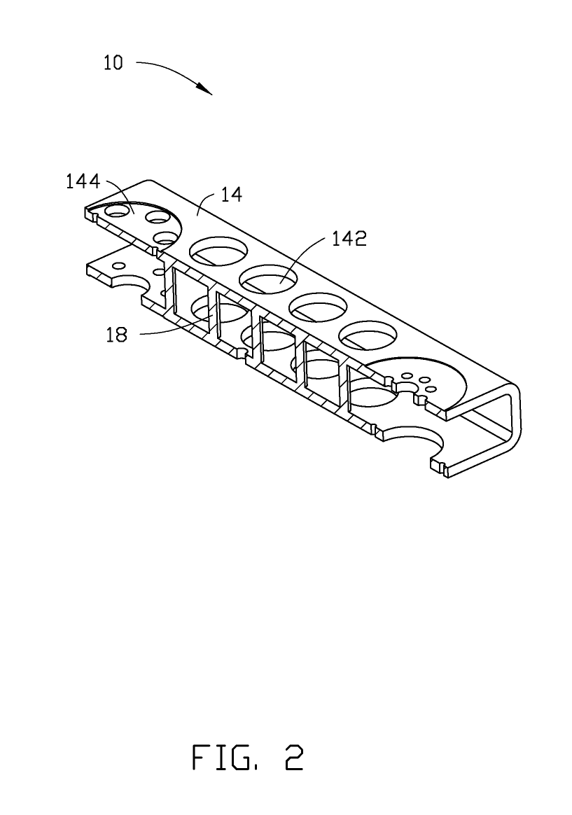

FIGS. 1 and 2 illustrate one embodiment of a mechanical arm structure 10. The mechanical arm structure 10 includes two side plates 12, two base plates 14, and a plurality of posts 18. The two side plates 12 are substantially parallel to each other. The two base plates 14 are substantially parallel to each other. Each base plate 14 is substantially perpendicular to the each side plate 12. Each side plate 12 connects the two base plates 14. The two side plates 12 and the two base plates 14 cooperatively define a space 16. In at least one embodiment, the mechanical arm structure 10 can be hollowed. A cross section of the mechanical arm structure 10 can be substantially rectangular.

The plurality of posts 18 is substantially parallel to each other and is substantially perpendicular to the two base plates 14. The plurality of posts 18 is substantially parallel to the two side plates 12. The plurality of posts 18 connects to the two base plates 14 and is located in the space 16. A plurality of projections of the posts 18 on the two base plates 14 is located on a straight line. Two distances from the straight line to the two side plates 12 are substantially equal. Each base plate 14 comprises two connecting portions 144 located on the two opposite sides of the each base plate 14. Each base plate 14 defines a plurality of holes 142. The shape of the plurality of holes 142 can be triangular, rectangular, or circular. The plurality of holes 142 is aligned in two rows along an extending direction of the two base plates 14. The plurality of holes 142 is evenly defined between the two connecting portions 144. A projection of each post 18 on one of the base plates 14 is located between two rows of the holes 142. A weight of each hole 142 reduced from the two base plates 14 can be greater than a weight of each post 18. In at least one embodiment, the shape of the plurality of holes 142 is circular. The shape of each post 18 is cylindrical. A diameter of one of the holes 142 is greater than a diameter of each post 18. A number of the plurality of holes 142 is greater than a number of the plurality of posts 18.

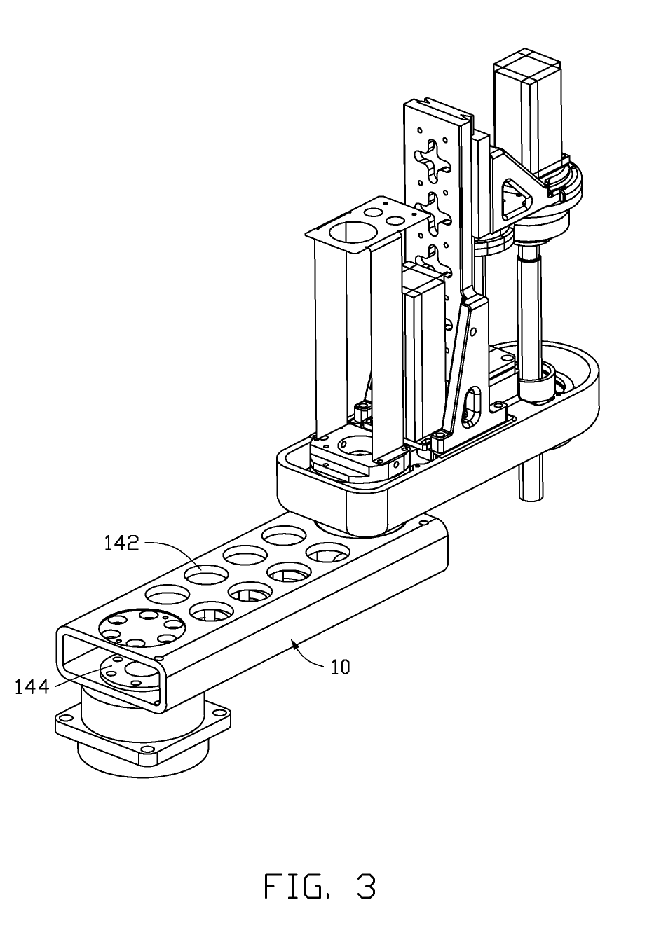

FIG. 3 illustrates a view of the mechanical arm structure 10 in a working state. The two connecting portions 144 are respectively connected to a fixing portion and an operating portion. An end of the mechanical arm structure 10 connected with the operating portion is forced to move along a direction which is perpendicular to the base plate 14. The plurality of posts 18 enhances the rigidity of the mechanical arm structure 10 along the direction perpendicular to the base plate 14. The moving direction is substantially perpendicular to the base plate 14.

FIGS. 1 and 2 also illustrate one embodiment of a plate.

The embodiments shown and described above are only examples. Many details are often found in the art such as the other features of a mechanical arm structure. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A mechanical arm structure comprising:
two base plates being substantially parallel to each other, and at least one of the two base plates defining a plurality of holes; and
a plurality of posts connecting the two base plates to enhance rigidity of the mechanical arm structure along the direction perpendicular to the two base plates.

2. The mechanical arm structure of claim 1, wherein the mechanical arm structure further comprises two side plates, the two side plates and the two base plates cooperatively define a space, and the plurality of posts is located in the space.

3. The mechanical arm structure of claim 2, wherein a cross section of the mechanical arm structure is substantially rectangular.

4. The mechanical arm structure of claim 1, wherein the plurality of holes is aligned in two rows along an extending direction of the two base plates.

5. The mechanical arm structure of claim 4, wherein a projection of each post on the one of the two base plates is located between the two rows of the holes.

6. The mechanical arm structure of claim 1, wherein each base plate includes two connecting portions, and the plurality of holes is evenly defined between the two connecting portions.

7. The mechanical arm structure of claim 6, wherein the two connecting portions are located on two opposite ends of each base plate.

8. The mechanical arm structure of claim 1, wherein the plurality of projections of the posts on the one of the two base plates is located on a straight line, and two distances from the straight line to the two side plates are substantially equal.

9. The mechanical arm structure of claim 1, wherein the plurality of posts is cylindrical and the plurality of holes is circular, and a diameter of one of the plurality of holes is greater than a diameter of one of the plurality of posts.

10. The mechanical arm structure of claim 1, wherein an extending direction of the plurality of posts is substantially perpendicular to the two base plates.

11. A plate comprising:
two base plates being substantially parallel to each other, and at least one of the two base plates defining a plurality of holes; and
a plurality of posts connecting the two base plates to enhance rigidity of the mechanical arm structure along the direction perpendicular to the two base plates.

12. The plate of claim 11, wherein the plate further comprises two side plates, the two side plates and the two base plates cooperatively define a space, and the plurality of posts is located in the space.

13. The plate of claim 12, wherein a cross section of the plate is substantially rectangular.

14. The plate of claim 11, wherein the plate can be hollowed, and the plurality of holes is aligned in two rows along an extending direction of the two base plates.

15. The plate of claim 14, wherein a projection of each post on the one of the two base plates is located between the two rows of the holes.

16. The plate of claim 11, wherein each base plate includes two connecting portions, the plurality of holes is evenly defined between the two connecting portions.

17. The plate of claim 16, wherein the two connecting portions are located on two opposite ends of each base plate.

18. The plate of claim 11, wherein a plurality of projections of the posts on the one of the two base plates is located on a straight line, and two distances from the straight line to the two side plates are substantially equal.

19. The plate of claim 11, wherein the plurality of posts is cylindrical and the plurality of holes is circular, and a diameter of one of the plurality of holes is greater than a diameter of one of the plurality of posts.

20. A mechanical arm structure with enhanced rigidity and reduced weight, comprising:
a first base plate;
a second base plate, spaced away from and substantially parallel to the first base plate;
a plurality of posts connecting the first base plate to the second base plate, and substantially perpendicular to the first base plate and the second base plate;
wherein, a plurality of holes is defined in the first base plate and the second base plate to reduce the weight of the arm structure; and
wherein, the plurality of connecting posts enhances the rigidity of the arm structure.
